(19) United States
(12) Patent Application Publication
(10) Pub. No.: US 2020/0179195 A1
(43) Pub. Date: Jun. 11, 2020

(54) WHEELCHAIR

(71) Applicant: TUNG KENG ENTERPRISE CO., LTD., Taichung City (TW)

(72) Inventor: Chia-Yen Huang, Taichung City (TW)

(73) Assignee: TUNG KENG ENTERPRISE CO., LTD., Taichung City (TW)

(21) Appl. No.: 16/214,578

(22) Filed: Dec. 10, 2018

(51) Int. Cl. A61G 5/12; A61G 5/10; A61G 5/02; A61G 5/04

(52) U.S. Cl. CPC A61G 5/125; A61G 5/128; A61G 5/04; A61G 5/1035; A61G 5/024; A61G 5/1051

(57) ABSTRACT

A wheelchair comprises a chair frame, two armrest support rods, two armrests, a plurality of wheels, and at least one pedal mechanism. The two armrest support rods connect the chair frame in a telescopic manner, and located at two sides of the chair frame, respectively. The two armrests connect the two armrest support rods, respectively, and can be moved forward and backward relative to the connected armrest support rods in a horizontal direction. The plurality of wheels connects a base portion of the chair frame. The at least one pedal mechanism includes a connecting rod and a foot pedal. The connecting rod is pivotally mounted at a front side of the chair frame, and the foot pedal is pivotally connected to the connecting rod, so that the connecting rod may drive the foot pedal to pivot about the pivotally connected end. Similarly, the foot pedal can also pivot relative to the connecting rod. Through the above design, the wheelchair can be adjusted according to the user's physique and requirement.

### BACKGROUND OF THE INVENTION

### Technical Field

The present invention is related to a mobility aid, and, more particularly, to a wheelchair.

### Description of Related Art

Medical technology is changing with each passing day, making modern people live longer, but longevity is still inevitably accompanied with functional aging of various organs in the body. Aging causes the body to lose calcium easily, muscle deficiency or limb degeneration. At this time, people's daily lifes often rely on wheelchairs for easy mobility. Besides, people also need to rely on wheelchairs after being injured by accidents or having difficulty in walking due to illness. Therefore, wheelchairs are one of the best mobility aids for people with impaired mobility.

The pedals of the conventional wheelchair are arranged such that when the user wants to get up from the posture of sitting in the wheelchair, the foot must be stretched forward and crossing over the pedal to step on the ground so that the user may stand up. As a result, the user with a petite figure often faces the trouble of crossing, or the user with weaker lower limbs is unstable or not convenient to stand up because the foot is stretched forward and too far from the torso. Therefore, the improvement of the pedal is a subject worth of concern.

In addition, adjustment of the armrest is another concern. The armrest of a conventional wheelchair can only be adjusted upwards or downwards in the vertical direction. Although the height of the adjusted armrest is increased, the length in the horizontal direction does not increased or decreased correspondingly, which is likely to cause the user to have a poor sitting posture or physical discomfort, or unable to control the remote controller on the armrest smoothly due to the improper length of the armrest. Therefore, the conventional wheelchair cannot be adapted to users with different physiques and still needs to be improved.

### BRIEF SUMMARY OF THE INVENTION

In view of the above, the purpose of the present invention is to provide a wheelchair which can facilitate a user to get up from the wheelchair.

In addition, another purpose of the present invention is to provide a wheelchair which facilitates a user to adjust the position of the armrest relative to the human body in the horizontal direction and the vertical direction according to the individual physique and the comfort level of sitting in the wheelchair.

In order to achieve the above purposes, the present disclosure provides a wheelchair comprising a chair frame, two armrest support rods, two armrests, a plurality of wheels, and at least one pedal mechanism The two armrest support rods are arranged at both sides of the chair frame and connected with one of the two armrests, respectively. The plurality of wheels is connected to a base portion of the chair frame. The at least one pedal mechanism includes a connecting rod and a foot pedal. One end of the connecting rod is pivotally mounted at a front side of the chair frame, and the other end of the connecting rod is pivotally connected to the foot pedal.

In order to achieve the above purposes, furthermore, the two armrest support rods of the wheelchair include a first rod and a second rod, respectively. The first rod is connected to the chair frame, and the second rod is configured on the first rod and movable relative to the first rod such that an end portion of the second rod is displaced in the horizontal direction and the vertical direction.

The advantage of the present invention is that the foot pedal is pivotally mounted at the front side of the chair frame through the connecting rod, so that when the user wants to get up from the state of sitting in the wheelchair, the foot pedal can be pushed by the feet (for example, the heel) to pivot toward the chair frame. Therefore, the feet can be stepped on the ground closer to the torso, so that the standing position of the feet is closer to the center of gravity of the user to facilitate the user getting up from the wheelchair. Moreover, the design of the armrest support rod enables the adjustment of the armrest connected with the armrest support rod in height and horizontal distance, so that the armrest can be adjusted horizontally and vertically according to the needs of different users.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view showing a wheelchair in accordance with a preferred embodiment of the present invention;

FIG. 2 is a schematic view showing the extension and retraction of the armrest support rod of the wheelchair in accordance with the above preferred embodiment;

FIG. 3 is a cross-sectional view taken along line 3-3 at the joint of the armrest and the armrest support rod of FIG. 1;

FIG. 4a is a partially enlarged view of FIG. 3, showing the position of the control portion 34b when the armrest 30 is fixed;

FIG. 4b is a partially enlarged view of FIG. 3, showing the position of the control portion 34b when the armrest 30 is movable;

FIG. 5 is a schematic view showing the horizontal movement of the armrest of the wheelchair in accordance with the above preferred embodiment;

FIG. 6 is a schematic view showing the moving of the pedal mechanism by the user;

FIG. 7 is a schematic view showing the movement of the pedal mechanism of FIG. 6; and

FIG. 8 is a schematic view showing the folding of the foot pedal.

### DETAILED DESCRIPTION OF THE INVENTION

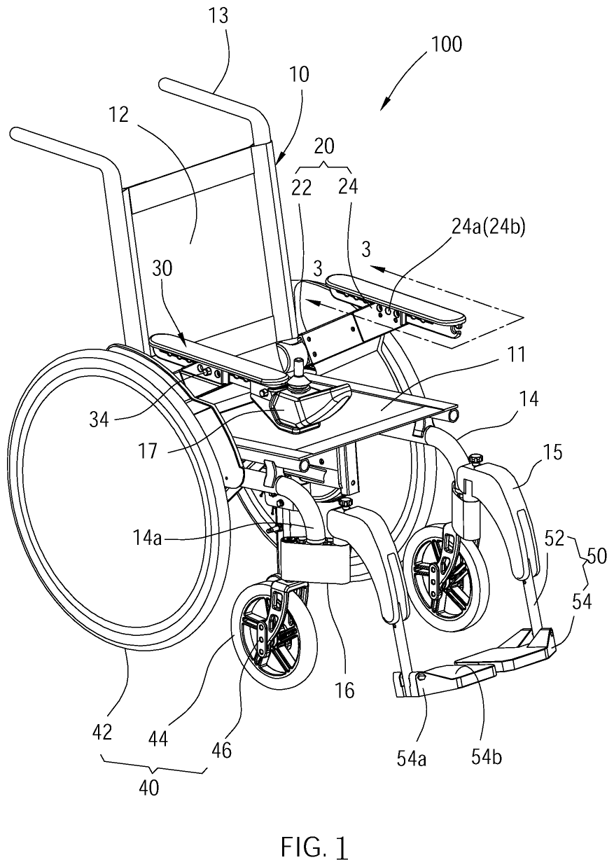

In order to explain the present invention more clearly, a preferred embodiment will be described in detail with reference to the drawings. Referring to FIG. 1 to FIG.6, a wheelchair 100 according to the preferred embodiment of the present invention includes a chair frame 10, two armrest support rods 20, two armrests 30, a plurality of wheels 40, and at least one pedal mechanism 50.

The chair frame 10 is used for the user to sit. The two armrest support rods 20 are connected to the chair frame 10 and are respectively located at two sides of the chair frame 10. The two armrests 30 are respectively connected to the two armrest support rods 20. The wheels 40 are connected to a base portion of the chair frame 10. The pedal mechanism 50 is pivotally mounted at a front side of the chair frame 10 and may be pivoted between a first position P1 and a second position P2. At the first position P1, the pedal mechanism 50 is relatively far from the chair frame 10, and at the second position P2, the pedal mechanism 50 is relatively close to the chair frame 10.

The construction and connection relationship of the above components will be described in detail below.

In the present embodiment, the chair frame 10 includes a seat 11 and a seat back 12. The seat 11 is used for the user to sit and provides support to the user's buttocks. The seat back 12 is located at the rear side of the chair frame 10 for the user to lean his back. The top of the seat back 12 is provided with two grips 13, which are arranged on two sides of the seat back 12 in an equal height and parallel manner The two grips 13 may be gripped for the push of the wheelchair 100. Further, in the present embodiment, the chair frame 10 further includes a main frame 14 and at least one support frame 15. The main frame 14 is provided with the seat 11 and the seat back 12. The support frame 15 is connected to the main frame 14 with a connecting member 16. The support frame 15 is pivotally connected to the connecting member 16, so that the support frame 15 can be pivoted laterally relative to the chair frame 10. The support frame 15 is provided with a plurality of first positioning portions 15a. In the present embodiment, there are two support frames 15 and connecting members 16. The main frame 14 is arranged under the seat 11 and connected to both sides of the seat 11. The side of the main frame 14 far from the seat back 12 is called the front side, where two connecting ends 14a are arranged to connect the two connecting members 16 respectively. Meanwhile, the two connecting members 16 are also located at two sides of the seat 11, respectively.

In the present embodiment, the structures of the two armrest support rods 20 are substantially the same, so only one of the structures of the armrest support rods 20 will be described in detail below.

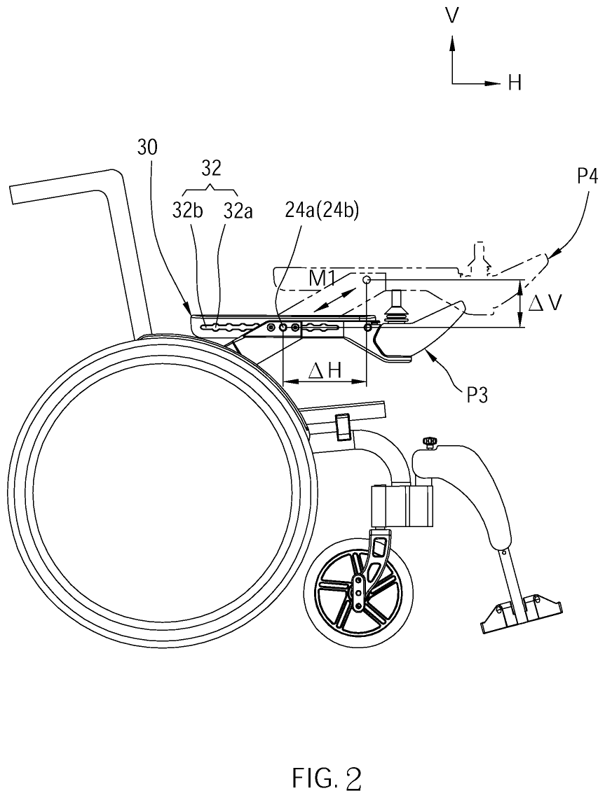

The armrest support rod 20 has a first rod 22 and a second rod 24. One end of the first rod 22 is configured on the chair frame 10 and near the joint of the seat back 12 and the seat 11. The first rod 22 can be pivotally swung between the seat back 12 and the seat 11 by means of the pivotal connection. The second rod 24 is mounted on the first rod 22 in such a manner as to be diagonally displaced along the extending direction of the first rod 22. The second rod 24 is movable relative to the first rod 22 between a third position P3 and a fourth position P4. When the second rod 24 is moved from the third position P3 to the fourth position P4 or from the fourth position P4 to the third position P3, the second rod 24 is displaced AH in the horizontal direction H and AV in the vertical direction V (see FIG. 2). An end portion 24a of the second rod 24 is used to connect the armrest 30. Further, in the present embodiment, the first rod 22 has an accommodating space therein, and an opening is formed at one end of the first rod 22 to communicate with the accommodating space. One end of the second rod 24 extends into the accommodating space via the opening to join with the first rod 22. Through the above design, the armrest support rod 20 is pivotally mounted on the seat back 12 in a telescopic manner

The two armrests 30 are respectively connected to the two armrest support rods 20 for the user to place the arms. In the present embodiment, the two armrests 30 are respectively mounted on the second rods 24 so as to be movable in the horizontal direction relative to the corresponding armrest support rods 20, and are respectively connected to the end portions 24a of the second rods 24.

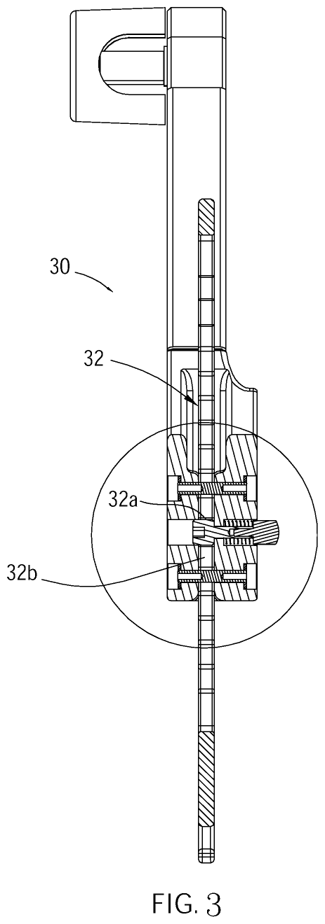

As shown in FIG. 3, each of the armrests 30 has a sliding rail 32. The sliding rail 32 includes a plurality of fixing holes 32a and a plurality of sliding slots 32b communicating with the plurality of fixing holes 32a. In the vertical direction V, the inner diameter of the fixing hole 32a is larger than the slot height of the sliding slot 32b.

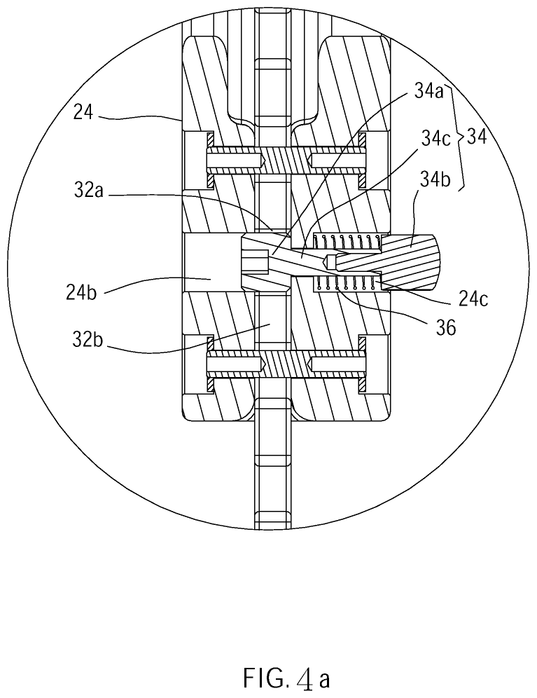

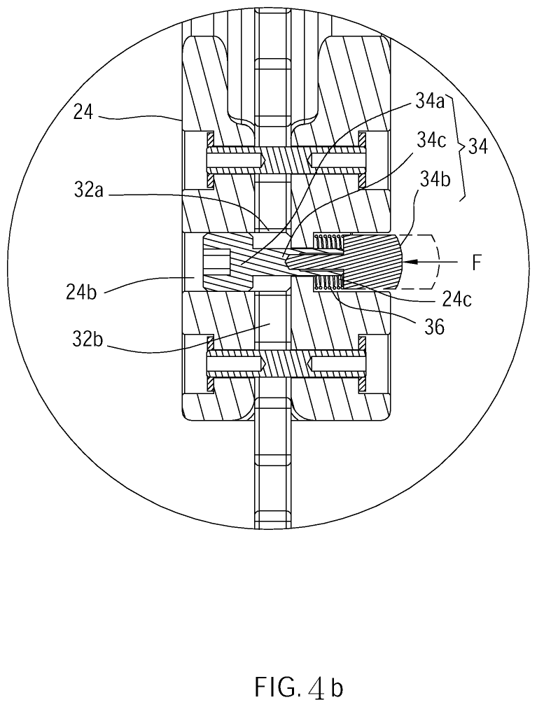

As shown in FIG. 4a and FIG. 4b, the end portion 24a of the second rod 24 has a rod body 34, a first accommodating groove 24b, and a second accommodating groove 24c. The first accommodating groove 24b is communicating with the second accommodating groove 24c. The rod body 34 has a fixing portion 34a, a control portion 34b, and a movable portion 34c. The fixing portion 34a and the control portion 34b are located at two ends of the rod body 34, respectively, and the middle of the rod body 34 is the movable portion 34c. The fixing portion 34a is located in the first accommodating groove 24b, and the control portion 34b is located in the second accommodating groove 24c.

The rod body 34 is disposed inside the sliding rail 32. The outer diameter of the fixing portion 34a and the control portion 34b is larger than the outer diameter of the movable portion 34c. The outer diameter of the fixing portion 34a and the control portion 34b is also larger than the slot length of the sliding slot 32b in the sliding direction of the rod body, but smaller than the inner diameter of the fixing hole 32a, so that the rod body 34 can only be fixed inside the fixing hole 32a. The outer diameter of the movable portion 34c is smaller than the slot height of the sliding slot 32b, so that only the movable portion 34c of the rod body 34 can be moved through the sliding rail 32. A spring 36 is disposed at the side of the fixing portion 34a facing the control portion 34b and sleeved around the movable portion 34c. One end of the spring 36 abuts against one side of the control portion 34b, and the other end of the spring 36 abuts against the bottom of the second accommodating groove 24c close to the first accommodating groove 24b.

Referring to FIG. 4a, when the armrest 30 is in a fixed state, one part of the fixing portion 34a of the rod body 34 abuts against the fixing hole 32a, and the other part of the fixing portion 34a is located in the first accommodating groove 24b, meanwhile the spring 36 is in the normal state (for example, in the uncompressed or stretched state). When the user wants to adjust the armrest 30 so that the armrest 30 can be moved horizontally relative to the end portion 24a of the second rod 24, the user must first push the control portion 34b of the rod body 34 with a force F (as shown in FIG. 4b) to presses the spring 36, which moves the movable portion 34c of the rod body 34 into the fixing hole 32a accordingly and locates the whole fixing portion 34a in the first accommodating groove 24b. Meanwhile, the movable portion 34c can move along the sliding rail 32 through the fixing hole 32a and the sliding slot 32b to the next fixing hole 32a, thereby driving the armrest 30 to move forward or backward with respect to the end portion 24a of the second rod 24. When adjusting to the appropriate position, the user need only release the control portion 34b and allow the spring 36 to return to the normal state from the compressed state, so that the fixing portion 34a is moved again into the corresponding fixing hole 32a and abutted therein to fix the horizontal position of the armrest 30.

In other applications, the manner in which the armrest 30 can be moved in the horizontal direction relative to the armrest support rod 20 is not limited to the above, and an axle or an equivalent sliding element may be provided to enable the forward and backward movement M2 of the armrest 30 in the horizontal direction.

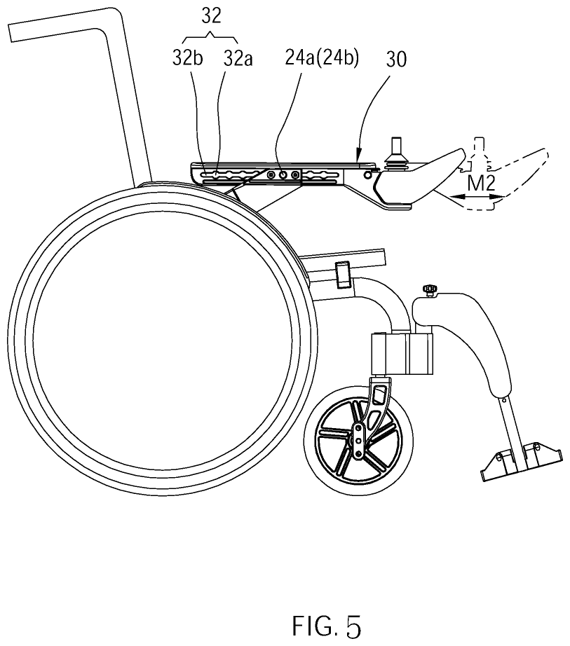

By the designs of the diagonal displacement M1 of the armrest support rod 20 (as shown in FIG. 2) and the forward and backward movement M2 of the armrest 30 in the horizontal direction (as shown in FIG. 5), the user can adjust the relative positions of the first rod 22 and the second rod 24 according to his sitting posture, the length of the arm or the distance between the shoulder and the elbow, thereby setting the height and extension distance of the armrest support rod 30 proper for the individual. The distance of the armrest suitable for the individual can be set by adjusting the horizontal position of the armrest 30. For example, when the arm is placed on the armrest 30, a user with a short stature can avoid discomfort such as shrugging or inability to fully relax due to the too high or too far armrest 30. In addition, in the present embodiment, a remote controller 17 is further arranged at the front end of one of the armrests 30 to control the operation of the wheelchair 100, such as moving or lifting. The design of the armrest 30 and the armrest support rod 20 allows the user to easily adjust the position and distance of the armrest support rod 20, the armrest 30, and the remote controller 17, thereby facilitating the user to sit in the wheelchair 100 and operate the remote controller 17 in a comfortable state.

In the embodiment, the wheels 40 include two main wheels 42 and two driven wheels 44. The two main wheels 42 are disposed under the chair frame 10 and near the seat back 12, and are respectively located at both sides of the chair frame 10 and connected to the main frame 14. Each driven wheel 44 is pivotally connected to a connecting member 16 through a wheel rod 46.

In addition, in an embodiment, there may also be only one connecting member 16. In this case, the two connecting ends 14a at the front side of the main frame 14 would be connected due to the arrangement of the connecting member 16, and there can also be arranged only one driven wheel 44 and one support frame 15 at this time. Further, the main frame 14 and the connecting member 16 may be formed integrally and are not limited to the above configuration.

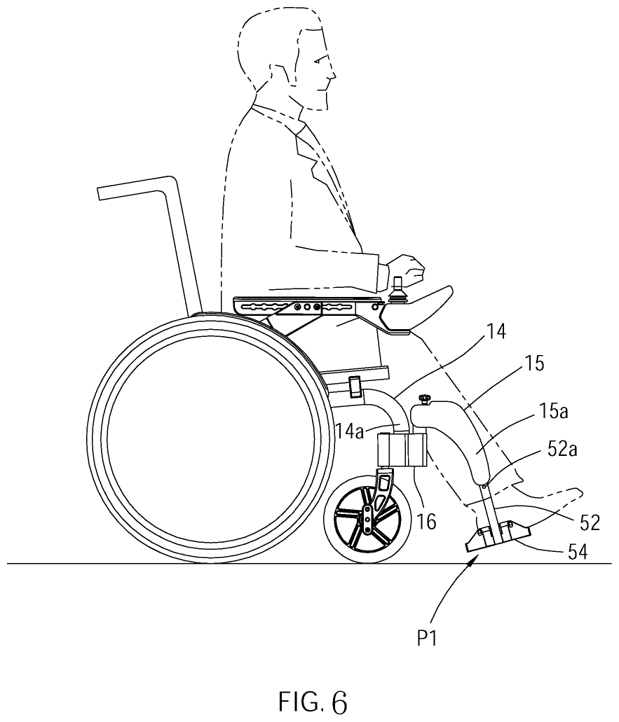

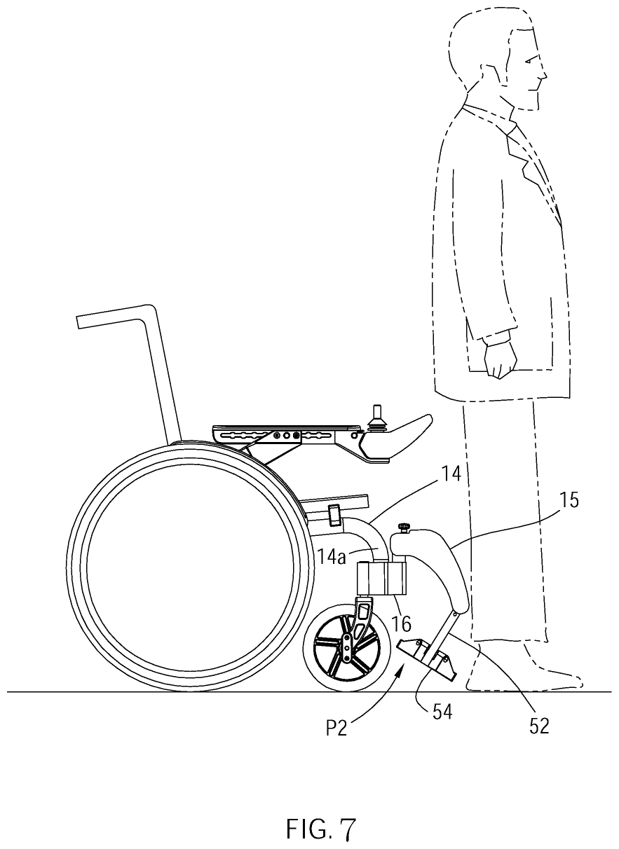

In the present embodiment, the at least one pedal mechanism 50 is exemplified by two pedal mechanisms 50. Each of the pedal mechanisms 50 includes a connecting rod 52 and a foot pedal 54. One end of the connecting rod 52 is pivotally configured at the front side of the chair frame 10, for example, pivotally connected to the support frame 15, and the other end of the connecting rod 52 is connected to the foot pedal 54. As shown in FIG. 6 and FIG. 7, the connecting rod 52 can be pivoted between a first position P1 and a second position P2. In the first position P1, the foot pedal is relatively far from the chair frame, and in the second position P2, the foot pedal is relatively close to the chair frame. In addition, the connecting rod 52 has a plurality of second positioning portions 52a for connecting the corresponding first positioning portions 15a of the support frame 15. In particular, the connecting rod 52 and the support frame 15 are connected in two connection manners.

In the first connection manner, one of the second positioning portions 52a of the connecting rod 52 and one of the first positioning portion 15a of the support frame 15 are bolted.

In the second connection manner, the connecting rod 52 may be joined with two or more of the first positioning portion 15a of the support frame 15 through two or more of the second positioning portions 52a, and the joining manner can be bolting or screwing.

Through the above two connection manners, the user can freely select between two use states. In the first use state corresponding to the first connection manner, the connecting rod 52 can pivotally swing relative to the support frame 15; and in the second use state, the connecting rod is fixed to the support frame 15 and cannot be pivotally swung.

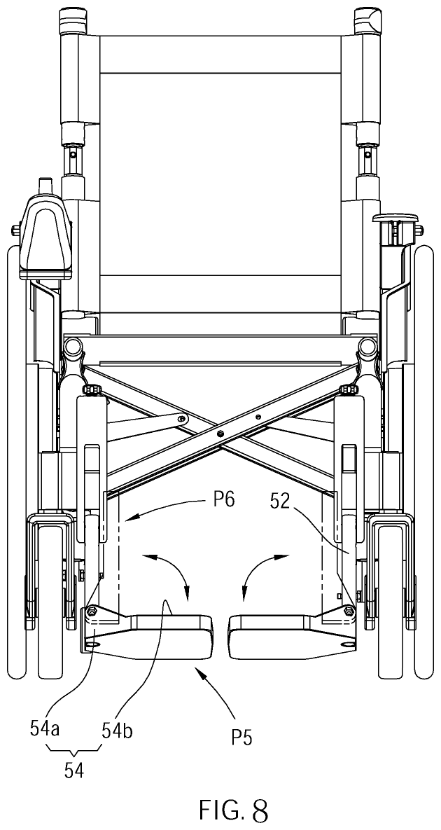

Referring to FIG. 8, the foot pedal 54 has a connecting portion 54a and a pedal portion 54b. The foot pedal 54 is connected to one of the connecting rods 52 by a connecting portion 54a, and the pedal portion 54b is used for user's foot to step on. Further, in this embodiment, the connecting portion 54a of the foot pedal 54 is pivotally connected to the other end of the connecting rod 52, so that the foot pedal 54 can be pivoted between a service position P5 and a storage position P6 by using a portion pivotally connected to the connecting rod 52 as a fulcrum. In the service position P5, the pedal portion 54b is relatively far from the connecting rod 52, and in the storage position P6, the pedal portion 54b is relatively close to the connecting rod 52.

In addition, in other applications, the number of at least one pedal mechanism 50 may be one, and the pedal mechanism includes one connecting rod or two connecting rods and one foot pedal (not shown). The number of the connecting rod is corresponding to the number of the support frame. If there are two connecting rods, the connecting rods are respectively disposed at two ends of the foot pedals. If there is one connecting rod, the connecting rod is disposed in the middle of the foot pedal or at the side wall of the foot pedal adjacent to the chair frame.

By the above design, when the user wants to get up from the sitting state, there are various ways to prevent the foot pedal 54 from obstructing the foot, so that the footstep won't be too large while the foot steps on the ground, thereby preventing the center of gravity from being too far from the body to apply force. For example:

the two support frames 15 are pivoted laterally, so that the two connected foot pedals 54 are also located on both sides of the chair frame 10, and a space is provided in the middle for the user to step on the ground;

the connecting rod 52 pivots relative to the support frame 15, and the foot pedal 54 is accordingly swung with the connecting rod 52, so that the user can push the foot pedal 54 by the foot to pivot the foot pedal 54 toward the chair frame 10, which is beneficial for the user to step on the ground; and

when the pedal portion 54b is pivoted to rest at the storage position P6, the spacing between the two foot pedals 54 is enlarged, and the user can step on the ground by using the spacing, which is beneficial for the user to stand up after stabilizing his footstep.

It must be pointed out that the embodiments described above are only some embodiments of the present invention. All equivalent structures which employ the concepts disclosed in this specification and the appended claims should fall within the scope of the present invention.

What is claimed is:

1. A wheelchair, comprising:
a chair frame;
two armrest support rods connecting the chair frame and located at two sides of the chair frame respectively;
two armrests connecting the two armrest support rods, respectively;
a plurality of wheels connecting a base portion of the chair frame; and
at least one pedal mechanism including a connecting rod and a foot pedal, wherein one end of the connecting rod is pivotally mounted at a front side of the chair frame, the other end of the connecting rod is connected to the foot pedal, the connecting rod is pivoted between a first position and a second position, when the connecting rod is at the first position, the foot pedal is relatively far from the chair frame, and when the connecting rod is at the second position, the foot pedal is relatively close to the chair frame.

2. The wheelchair of claim 1, wherein each of the two armrest support rods has a first rod and a second rod, the first rod connects the chair frame, the second rod is configured on the first rod, an end portion of the second rod is connected to one of the two armrests, the second rod is movable relative to the first rod between a third position and a fourth position, and when the second rod is moved from the third position to the fourth position, the end portion is displaced in the horizontal direction and the vertical direction.

3. The wheelchair of claim 2, wherein the second rod is mounted on the first rod in such a manner as to be diagonally displaced along the extending direction of the first rod.

4. The wheelchair of claim 2, wherein the end portion of the second rod is provided with a rod body, the armrest includes a sliding rail, and the rod body is disposed inside the sliding rail such that the end portion of the second rod is connected to the armrest.

5. The wheelchair of claim 1, wherein the two armrests are respectively mounted on the two armrest support rods in such a manner as to be movable in a horizontal direction relative to the two armrest support rods.

6. The wheelchair of claim 2, wherein the two armrests are respectively mounted on the two armrest support rods in such a manner as to be movable in a horizontal direction relative to the two armrest support rods.

7. The wheelchair of claim 3, wherein the two armrests are respectively mounted on the two armrest support rods in such a manner as to be movable in a horizontal direction relative to the two armrest support rods.

8. The wheelchair of claim 1, wherein the chair frame includes a main frame and at least one support frame, the at least one support frame is mounted at a front side of the main frame and having a plurality of first positioning portions, and in a first use state, the connecting rod of the at least one pedal mechanism is pivotally connected to one of the first positioning portions and pivotally swung relative to the at least one support frame.

9. The wheelchair of claim 8, wherein the connecting rod has a plurality of second positioning portions; and in a second use state, at least two of the plurality of second positioning portions are joined with at least two of the plurality of first positioning portions to prevent the connecting rod from pivotally swinging relative to the at least one support frame.

10. The wheelchair of claim 4, wherein the number of the at least one pedal mechanism is two, the two foot pedals respectively have a connecting portion and a pedal portion, the two foot pedals are respectively pivotally connected to the two connecting rods by the connecting portion, so that each foot pedal is respectively pivoted between a service position and a storage position by using a portion pivotally connected to each of the connecting rods as a fulcrum, in the service position, the pedal portion is relatively far from the connecting rod, and in the storage position, the pedal portion is relatively close to the connecting rod.

11. The wheelchair of claim 5, wherein the number of the at least one pedal mechanism is two, the two foot pedals respectively have a connecting portion and a pedal portion, the two foot pedals are respectively pivotally connected to the two connecting rods by the connecting portion, so that each foot pedal is respectively pivoted between a service position and a storage position by using a portion pivotally connected to each of the connecting rods as a fulcrum, in the service position, the pedal portion is relatively far from the connecting rod, and in the storage position, the pedal portion is relatively close to the connecting rod.

12. The wheelchair of claim 6, wherein the number of the at least one pedal mechanism is two, the two foot pedals respectively have a connecting portion and a pedal portion, the two foot pedals are respectively pivotally connected to the two connecting rods by the connecting portion, so that each foot pedal is respectively pivoted between a service position and a storage position by using a portion pivotally connected to each of the connecting rods as a fulcrum, in the service position, the pedal portion is relatively far from the connecting rod, and in the storage position, the pedal portion is relatively close to the connecting rod.

13. The wheelchair of claim 7, wherein the number of the at least one pedal mechanism is two, the two foot pedals respectively have a connecting portion and a pedal portion, the two foot pedals are respectively pivotally connected to the two connecting rods by the connecting portion, so that each foot pedal is respectively pivoted between a service position and a storage position by using a portion pivotally connected to each of the connecting rods as a fulcrum, in the service position, the pedal portion is relatively far from the connecting rod, and in the storage position, the pedal portion is relatively close to the connecting rod.

14. The wheelchair of claim 9, wherein the number of the at least one support frame is two, and each support frame is pivotally connected to a front end of the main frame and pivoted laterally relative to the main frame.
